(19) United States
(12) Patent Application Publication
(10) Pub. No.: US 2026/0346877 A1
(43) Pub. Date: Nov. 5, 2026

(54) SCENARIO-BASED PREDICTION

(71) Applicant: HONDA MOTOR CO., LTD., Tokyo (JP)

(72) Inventors: Longchao DA, Tempe, AZ (US); Manish Rajesh SAROYA, Menlo Park, CA (US); David Francis ISELE, Sunnyvale, CA (US); Jovin J. D'SA, San Jose, CA (US); Sangjae BAE, Mountain View, CA (US)

(21) Appl. No.: 19/663,333

(22) Filed: Apr. 30, 2026

Related U.S. Application Data
(60) Provisional application No. 63/798,276, filed on May 1, 2025.

(51) Int. Cl. B60W 60/00

(52) U.S. Cl. CPC B60W 60/00274; B60W 2554/408

(57) ABSTRACT

According to one aspect, scenario-based prediction may include generating a probability that a traffic scenario is of a first scenario type or a second scenario type based on one or more past trajectories of one or more traffic participants from the traffic scenario and a scenario neural network, generating one or more predicted trajectories for one or more traffic participants from the traffic scenario based on the one or more past trajectories and a predictor, evaluating the predictor based on a score calculated based on the probability that the traffic scenario is the first scenario type or the second scenario type, an area diversity model, and a geometric error model, and generating a planned trajectory for an ego-vehicle based on the one or more predicted trajectories and the probability that the traffic scenario is of the first scenario type or the second scenario type.

### CROSS-REFERENCE TO RELATED APPLICATIONS

This application claims the benefit of U.S. Provisional Patent Application, Ser. No. 63/798,276 (Attorney Docket No. H1251296US01) entitled “SCENARIO-DRIVEN PREDICTION EVALUATION FRAMEWORK FOR ENHANCING AUTONOMOUS DRIVING PERFORMANCE”, filed on May 1, 2025; the entirety of the above-noted application(s) is incorporated by reference herein.

### BACKGROUND

Self-driving vehicles (SDVs) face significant challenges, primarily regarding safety, technological limitations, and ethical/regulatory issues. Major problems include failure to detect pedestrians or cyclists, confusion in complex traffic scenarios, vulnerability to hacking, and unpredictable performance in bad weather. SDVs often struggle when the real world doesn't match their training data, leading to accidents.

In this regard, trajectory prediction is a fundamental component of autonomous driving systems. It allows a planner to anticipate the future movements of surrounding agents, including vehicles, pedestrians, and cyclists, enabling proactive and efficient decision-making. A typical SDV pipeline may include perception, planning, and control modules. The perception module may detect nearby agents and uses a trajectory predictor to forecast their possible future behaviors. The planner may generate the ego-vehicle's trajectory based on these predictions, traffic rules, and map information. High-quality predictions are crucial to ensure efficiency and passenger comfort.

### BRIEF DESCRIPTION

According to one aspect, a system for scenario-based prediction may include a memory and a processor. The memory may store one or more instructions. The processor may execute one or more of the instructions stored on the memory to perform one or more acts, actions, and/or steps. The processor may perform generating a probability that a traffic scenario is of a first scenario type or a second scenario type based on one or more past trajectories of one or more traffic participants from the traffic scenario and a scenario neural network. The processor may perform generating one or more predicted trajectories for one or more traffic participants from the traffic scenario based on the one or more past trajectories and a predictor. The processor may perform evaluating the predictor based on a score calculated based on the probability that the traffic scenario is the first scenario type or the second scenario type, an area diversity model, and a geometric error model.

The processor may perform generating a planned trajectory for an ego-vehicle of one or more of the traffic participants based on the one or more predicted trajectories and the probability that the traffic scenario is of the first scenario type or the second scenario type. The processor may perform implementing the planned trajectory for the ego-vehicle using one or more vehicle systems of the ego-vehicle. The first scenario type may be a scenario including an intersection and the second scenario type may be a scenario including a highway or a roadway without intersections. The processor may perform transforming the one or more past trajectories of the one or more traffic participants from the traffic scenario into a graph format for the scenario neural network. The area diversity model may be a Gaussian Mixture Model (GMM) area diversity model (GAD). The area diversity model may generate an output indicative of a spatial spread of the one or more predicted trajectories. The geometric error model may generate an output indicative of average displacement error (ADE). The score may be equal to the probability that the traffic scenario is the first scenario type multiplied by an output of the area diversity model summed with the probability that the traffic scenario is the second scenario type multiplied by an output of the geometric error model. The processor may perform updating the predictor based on the score.

According to one aspect, a computer-implemented method for scenario-based prediction may include generating a probability that a traffic scenario is of a first scenario type or a second scenario type based on one or more past trajectories of one or more traffic participants from the traffic scenario and a scenario neural network, generating one or more predicted trajectories for one or more traffic participants from the traffic scenario based on the one or more past trajectories and a predictor, and evaluating the predictor based on a score calculated based on the probability that the traffic scenario is the first scenario type or the second scenario type, an area diversity model, and a geometric error model.

The computer-implemented method for scenario-based prediction may include generating a planned trajectory for an ego-vehicle of one or more of the traffic participants based on the one or more predicted trajectories and the probability that the traffic scenario is of the first scenario type or the second scenario type. The computer-implemented method for scenario-based prediction may include implementing the planned trajectory for the ego-vehicle using one or more vehicle systems of the ego-vehicle. The first scenario type may be a scenario including an intersection and the second scenario type may be a scenario including a highway or a roadway without intersections. The computer-implemented method for scenario-based prediction may include transforming the one or more past trajectories of the one or more traffic participants from the traffic scenario into a graph format for the scenario neural network.

According to one aspect, a system for scenario-based prediction may include one or more vehicle systems, a memory, and a processor. The memory may store one or more instructions. The processor may execute one or more of the instructions stored on the memory to perform one or more acts, actions, and/or steps. The processor may perform generating a probability that a traffic scenario is of a first scenario type or a second scenario type based on one or more past trajectories of one or more traffic participants from the traffic scenario and a scenario neural network. The processor may perform generating one or more predicted trajectories for one or more traffic participants from the traffic scenario based on the one or more past trajectories and a predictor. The processor may perform evaluating the predictor based on a score calculated based on the probability that the traffic scenario is the first scenario type or the second scenario type, an area diversity model, and a geometric error model. The processor may perform generating and implementing a planned trajectory for an ego-vehicle of one or more of the traffic participants based on the one or more predicted trajectories and the probability that the traffic scenario is of the first scenario type or the second scenario type using one or more of the vehicle systems.

The first scenario type may be a scenario including an intersection and the second scenario type may be a scenario including a highway or a roadway without intersections. The processor may perform transforming the one or more past trajectories of the one or more traffic participants from the traffic scenario into a graph format for the scenario neural network. The area diversity model may be a Gaussian Mixture Model (GMM) area diversity model (GAD). The area diversity model may generate an output indicative of a spatial spread of the one or more predicted trajectories.

### BRIEF DESCRIPTION OF THE DRAWINGS

FIG. 1 is an illustration of two different types of scenarios associated with trajectory prediction, according to one aspect.

FIG. 2 is a framework for an exemplary system for scenario-based prediction, according to one aspect.

FIG. 3 is a component diagram of an exemplary system for scenario-based prediction, according to one aspect.

FIG. 4 is a flow diagram of an exemplary computer-implemented method for scenario-based prediction, according to one aspect.

FIG. 5 is an illustration of an example computing environment where one or more of the provisions set forth herein are implemented, according to one aspect.

FIG. 6 is an illustration of an example computer-readable medium or computer-readable device including processor-executable instructions configured to embody one or more of the provisions set forth herein, according to one aspect.

### DETAILED DESCRIPTION

The following includes definitions of selected terms employed herein. The definitions include various examples and/or forms of components that fall within the scope of a term and that may be used for implementation. The examples are not intended to be limiting. Further, one having ordinary skill in the art will appreciate that the components discussed herein may be combined, omitted, or organized with other components or organized into different architectures.

A “processor”, as used herein, processes signals and performs general computing and arithmetic functions. Signals processed by the processor may include digital signals, data signals, computer instructions, processor instructions, messages, a bit, a bit stream, or other means that may be received, transmitted, and/or detected. Generally, the processor may be a variety of various processors including multiple single and multicore processors and co-processors and other multiple single and multicore processor and co-processor architectures. The processor may include various modules to execute various functions.

A “memory”, as used herein, may include volatile memory and/or non-volatile memory. Non-volatile memory may include, for example, ROM (read only memory), PROM (programmable read only memory), EPROM (erasable PROM), and EEPROM (electrically erasable PROM). Volatile memory may include, for example, RAM (random access memory), synchronous RAM (SRAM), dynamic RAM (DRAM), synchronous DRAM (SDRAM), double data rate SDRAM (DDRSDRAM), and direct RAM bus RAM (DRRAM). The memory may store an operating system that controls or allocates resources of a computing device.

A “disk” or “drive”, as used herein, may be a magnetic disk drive, a solid-state disk drive, a floppy disk drive, a tape drive, a Zip drive, a flash memory card, and/or a memory stick. Furthermore, the disk may be a CD-ROM (compact disk ROM), a CD recordable drive (CD-R drive), a CD rewritable drive (CD-RW drive), and/or a digital video ROM drive (DVD-ROM). The disk may store an operating system that controls or allocates resources of a computing device.

A “bus”, as used herein, refers to an interconnected architecture that is operably connected to other computer components inside a computer or between computers. The bus may transfer data between the computer components. The bus may be a memory bus, a memory controller, a peripheral bus, an external bus, a crossbar switch, and/or a local bus, among others. The bus may also be a vehicle bus that interconnects components inside a vehicle using protocols such as Media Oriented Systems Transport (MOST), Controller Area network (CAN), Local Interconnect Network (LIN), among others.

A “controller”, as used herein, may be a device implemented in hardware, firmware, software, or a combination thereof. A controller may include one or more CPUs (e.g., a central processing unit including one or more “processors”), a “memory”, a “storage drive”, a “bus”, and one or more programmable input/output (I/O) peripherals.

A “database”, as used herein, may refer to a table, a set of tables, and a set of data stores (e.g., disks) and/or methods for accessing and/or manipulating those data stores.

An “operable connection”, or a connection by which entities are “operably connected”, is one in which signals, physical communications, and/or logical communications may be sent and/or received. An operable connection may include a wireless interface, a physical interface, a data interface, and/or an electrical interface.

A “computer communication”, as used herein, refers to a communication between two or more computing devices (e.g., computer, personal digital assistant, cellular telephone, network device) and may be, for example, a network transfer, a file transfer, an applet transfer, an email, a hypertext transfer protocol (HTTP) transfer, and so on. A computer communication may occur across, for example, a wireless system (e.g., IEEE 802.11), an Ethernet system (e.g., IEEE 802.3), a token ring system (e.g., IEEE 802.5), a local area network (LAN), a wide area network (WAN), a point-to-point system, a circuit switching system, a packet switching system, among others.

A “mobile device”, as used herein, may be a computing device typically having a display screen with a user input (e.g., touch, keyboard) and a processor for computing. Mobile devices include handheld devices, portable electronic devices, smart phones, laptops, tablets, and e-readers.

A “vehicle”, as used herein, refers to any moving vehicle that is capable of carrying one or more human occupants and is powered by any form of energy. The term “vehicle” includes cars, trucks, vans, minivans, SUVs, motorcycles, scooters, boats, personal watercraft, and aircraft. In some scenarios, a motor vehicle includes one or more engines. Further, the term “vehicle” may refer to an electric vehicle (EV) that is powered entirely or partially by one or more electric motors powered by an electric battery. The EV may include battery electric vehicles (BEV) and plug-in hybrid electric vehicles (PHEV). Additionally, the term “vehicle” may refer to an autonomous vehicle and/or self-driving vehicle powered by any form of energy. The autonomous vehicle may or may not carry one or more human occupants.

A “vehicle system”, as used herein, may be any automatic or manual systems that may be used to enhance the vehicle, and/or driving. Exemplary vehicle systems include an autonomous driving system, an electronic stability control system, an anti-lock brake system, a brake assist system, an automatic brake prefill system, a low speed follow system, a cruise control system, a collision warning system, a collision mitigation braking system, an auto cruise control system, a lane departure warning system, a blind spot indicator system, a lane keep assist system, a navigation system, a transmission system, brake pedal systems, an electronic power steering system, visual devices (e.g., camera systems, proximity sensor systems), a climate control system, an electronic pretensioning system, a monitoring system, a passenger detection system, a vehicle suspension system, a vehicle seat configuration system, a vehicle cabin lighting system, an audio system, a sensory system, among others.

An “agent”, as used herein, may be a machine that moves through or manipulates an environment. Exemplary agents may include robots, vehicles, or other self-propelled machines. The agent may be autonomously, semi-autonomously, or manually operated.

Given various methodologies, it becomes a realistic question of how to select predictors to provide real-world driving planners with a reliable reference. Most prevalent strategies rely on displacement metrics, such as ADE and FDE, which measure the distance between predictions and ground truth. However, the predictor is not an isolated module: its output guides the planner, affecting the vehicle's decisions about braking, accelerating, or changing lanes. If evaluation criteria fail to capture meaningful differences among predictors that cause downstream changes, predictors that perform well on benchmark metrics may still lead to inefficient driving behaviors in practice.

Thus, being able to anticipate the motion of surrounding agents is useful for the efficient operation of autonomous driving systems in dynamic situations. Current evaluation practices rely on error-based metrics (e.g., Average Displacement Error (ADE), Final Displacement Error (FDE), etc.), which reveal the accuracy from a post-hoc view but ignore the actual effect the predictor brings to the self-driving vehicles (SDVs), especially in complex interactive scenarios. A high-quality predictor not only chases accuracy, but may also capture all possible directions a neighbor agent might move, to support the SDVs' cautious decision-making. Given that the existing metrics hardly account for this standard, a system for scenario-based prediction described herein may utilize a comprehensive pipeline that adaptively and beneficially or advantageously evaluates the predictor's performance by two dimensions including accuracy and diversity (e.g., by evaluating a score calculated based on an area diversity model and a geometric error model). Based on a criticality or type of a driving scenario, these two dimensions may be dynamically combined and result in a final score for the predictor's performance.

Historically, a predictor estimated future trajectories of surrounding agents, then a planner leveraged such information to plan for an ego-vehicle's future trajectory. However, according to one aspect described herein, a predictor evaluation may be beneficially calculated based on a scenario type, thereby enabling an evaluation of a predictor or model associated with the predictor, and allowing updates to the predictor to be made, if desired.

It has been shown that error-based measures indeed fail short in representing such downstream impact of predictors to planners, the ADE hardly reveals meaningful insights, a low displacement error doesn't imply improved SDV's driving performance or vice versa. Given this, solely relying on error-based measure is not enough to quantify the predictor's performance considering the real impact on SDV. Therefore, there is a need for a way to evaluate the performance of a predictor.

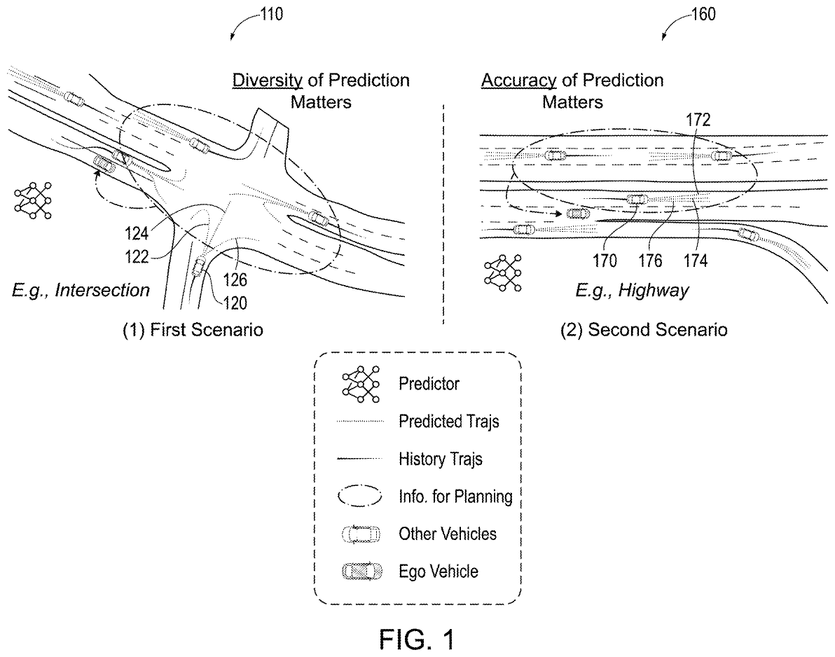

Under the analysis of these SDVs' driving scenarios and trajectories, it appears that a useful factor neglected by the displacement error is the complexity of the scenario. As shown in FIG. 1, in relatively simple scenarios, such as highway driving, where surrounding vehicles and the ego-vehicle share a steady uniform motion, the predictors only need to extrapolate future paths accurately from past observations. By contrast, in complex scenarios, such as intersections, the requirement for the predictor is not only to cover the correct trajectory in its prediction, but also to anticipate every plausible maneuver a neighboring agent might take. Such comprehensive coverage is useful for planners to make early, conservative decisions under uncertainty. Since real-world systems lack access to real-time ground truth feedback and high error tolerance may be undesirable, generating a diverse ensemble of possible futures becomes useful. Thus, the second challenge arises as: how to reasonably quantify the prediction diversity that helps the planner with rich information to make robust decision-making in challenging scenarios.

Others have introduced diversity and uncertainty-aware metrics, such as Average Minimum Volume (AMV), energy scores, and lane-aware distances, to encourage predictors to produce multiple plausible futures. However, these metrics are typically computed in an open-loop setting, that do not account for how prediction errors propagate through the planning pipeline. A few studies have begun to explore the closed-loop evaluation, but others apply the same criteria regardless of context. Consequently, a scenario-aware evaluation framework, as described herein, that dynamically weights diversity versus accuracy based on traffic context is desired.

It has been shown that conventional metrics for trajectory prediction fail to reflect the planner's performance. To resolve this, ED-Eva, a novel evaluation framework that balances the error metric and the diversity adaptively by the scenarios, in a closed-loop fashion is provided herein. Specifically, an adaptive classifier that takes a vehicle's interaction graph as input and outputs a weighting factor to determine importance of prediction diversity and accuracy is provided. To quantify prediction diversity in a robust and interpretable way, a Gaussian Mixture Model (GMM) Area Diversity (GAD) may be introduced. The GAD measures the spatial spread of predicted trajectories by fitting a Gaussian Mixture Model (GMM) and computing the area of the resulting uncertainty ellipse, which captures how well the predictor represents multimodal futures.

Thus, the system for scenario-based prediction described herein may fill a gap in existing predictor evaluation methods, because error-based metrics have been demonstrated to fail to reflect downstream planner performance. The system for scenario-based prediction may include a scenario-aware evaluation framework, Error and Diversity during Evaluation (ED-Eva), that adaptively balances prediction error and diversity during evaluation, aligning predictor performance with planning outcomes. Further, the system for scenario-based prediction may utilize a novel metric of GMM-Area Diversity (GAD) to robustly quantify the prediction spread.

Prediction quality may be evaluated by various metrics. Existing methods may be broadly categorized into two groups: accuracy-based metrics and diversity or uncertainty-aware metrics. However, others do not identify the criticality or type of scenarios.

Error-based Prediction Evaluation: Error-based metrics, such as ADE and FDE, measure geometric closeness between predicted and ground-truth trajectories. These metrics are widely used in trajectory prediction benchmarks due to their simplicity. Others have tried to account for the multimodal nature of trajectory prediction. Notably, aveADE/aveFDE average errors across all predicted modes, while minADE/minFDE report the best-case error. However, recent studies have shown error-based measures are insufficient for autonomous driving systems by the failure to capture multi-agent interactions, to account for the planner's downstream decision-making, and the lack of alignment with system-level objectives such as comfort.

Diversity and Uncertainty Evaluation: Diversity and uncertainty-aware evaluation methods encourage predictors to produce multiple plausible future trajectories rather than collapsing to a single mode. Metrics such as Average Minimum Volume (AMV), energy scores, and s-calibration-based assessments may measure how well predictions capture the multimodal nature of traffic behaviors. Lane-aware distance metrics and auxiliary losses have also been proposed to promote spatial plausibility and social compliance. However, these metrics are typically evaluated independently of the downstream planner and do not consider how prediction diversity or spread impacts planning outcomes like comfort.

Scenario Type Identification: Understanding the criticality or type of scenarios is useful to decide the risks of taking certain actions. There are others applying Long-Short Term Memory (LSTM) for scene understanding and risk assessment, while later graph-based interaction modeling provides a better capability in dynamic scene change capturing. Even though others have explored the scene risk and type assessment, few have considered the prediction evaluation based on scenario semantics. Others rely on predefined scenario categorizations prior to evaluation, which limits the adaptability of the evaluation method itself, due to the lack of automatic, context-aware assessment. Further, others do not consider the closed-loop impact from the prediction to the planner's action. By contrast, the closed-loop of predictor and planner described herein utilizes a scenario-adaptive evaluation framework that dynamically adjusts the preference between error-based measure and diversity of predictions.

FIG. 1 is an illustration of two different types of scenarios associated with trajectory prediction, according to one aspect. In a first scenario 110, different vehicles may be present in a more complex operating environment, such as an intersection, for example. In the first scenario 110, a first vehicle 120 may have multiple predicted trajectories 122, 124, 126. However, the multiple predicted trajectories 122, 124, 126 for the first vehicle 120 may be extremely diverse. In a second scenario 160, different vehicles may be present in a slightly less complex operating environment, such as a highway or roadway without any intersections nearby, for example. In the second scenario 160, a second vehicle 170 may have multiple predicted trajectories 172, 174, 176. However, the multiple predicted trajectories 172, 174, 176 for the second vehicle 170 may be less diverse. In the second scenario 160, the vehicles may be travelling at higher speeds or velocities, and accuracy of the predicted trajectories 172, 174, 176 may be important or a higher priority than the first scenario 110.

As shown in FIG. 1, in the first scenario 110, such as multiple vehicles interacting in the crossing, prediction diversity may be favored to make informative decisions, while in the second scenario 160, such as the highway scenario, the vehicles are moving relatively static relative to one another, and here, straightforward accuracy may be favored.

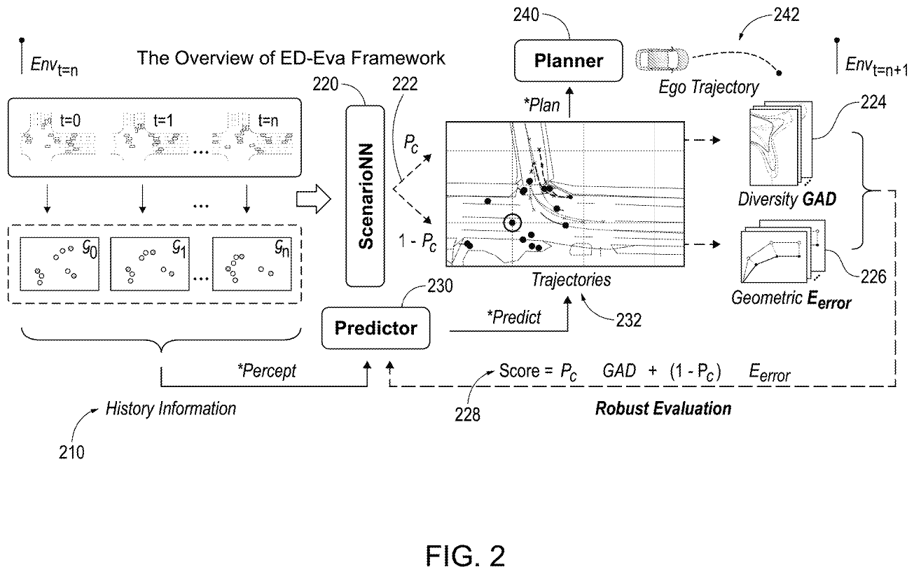

FIG. 2 is a framework for an exemplary system for scenario-based prediction, according to one aspect. One or more past trajectories of one or more traffic participants from a traffic scenario (e.g., history information 210) may be received. Additionally, the history information 210 may be transformed into a graph format or graph stack for a scenario neural network 220. The scenario neural network may be stored on a storage drive of a system for scenario-based prediction. The scenario neural network 220 may generate a probability 222 that a traffic scenario is of a first scenario type or a second scenario type based on the history information 210 (e.g., past trajectories of traffic participants from the traffic scenario). A predictor 230 may generate one or more predicted trajectories 232 for one or more of the traffic participants from the traffic scenario based on the history information 210.

An area diversity model 224 may be utilized to evaluate the predicted trajectories 232 generated by the predictor 230. A geometric error model 226 may be utilized to evaluate the predicted trajectories 232 generated by the predictor 230. The area diversity model 224 may generate an output indicative of a spatial spread of the one or more predicted trajectories based on the probability 222 that the traffic scenario is of the first scenario type or the second scenario type and based on the predicted trajectories 232. The geometric error model 226 may generate an output indicative of average displacement error (ADE) based on the predicted trajectories 232. The area diversity model 224 and the geometric error model 226 may be stored on a storage drive of a system for scenario-based prediction.

According to one aspect, a score 228 may be calculated, where the score is equal to the probability that the traffic scenario is the first scenario type multiplied by an output of the area diversity model summed with the probability that the traffic scenario is the second scenario type multiplied by an output of the geometric error model. The score 228 may be utilized to evaluate the predictor. Optionally, a model associated with the predictor may be updated based on the score. Similarly, the predictor may be stored on the storage drive of the system for scenario-based prediction.

A planner 240 may generate a planned trajectory 242 for an ego-vehicle of one or more of the traffic participants based on the one or more predicted trajectories 232 and the probability 222 that the traffic scenario is of the first scenario type or the second scenario type. Further, the planned trajectory 242 may be implemented for the ego-vehicle using one or more vehicle systems and/or actuators of the ego-vehicle.

According to one aspect, at Envₜ₌ₙ, given the n steps of history information, the predictor 230 may make predictions 232 for future trajectories, and the planner 240 may generate maneuvers for the ego-vehicle based on predictions 232, then the system moves to the next step Envₜ₌ₙ₊₁. An evaluation exists in this loop, where a spatial-temporal graph may be constructed and feature fed to the scenario neural network 220. The scenario neural network 220 may provide scenario type probability P_{c} (e.g., 222) based on complexity of the scenario. Thereafter, a diversity measure GAD 224 may be employed to capture the prediction's reasonable spread and a model 226 for the geometric Eₑᵣᵣₒᵣ to quantify their displacement error, they are dynamically weighted by the context of the traffic and come to the final evaluation score 228 that may reflect the predictor's 230 influence on the overall driving performance.

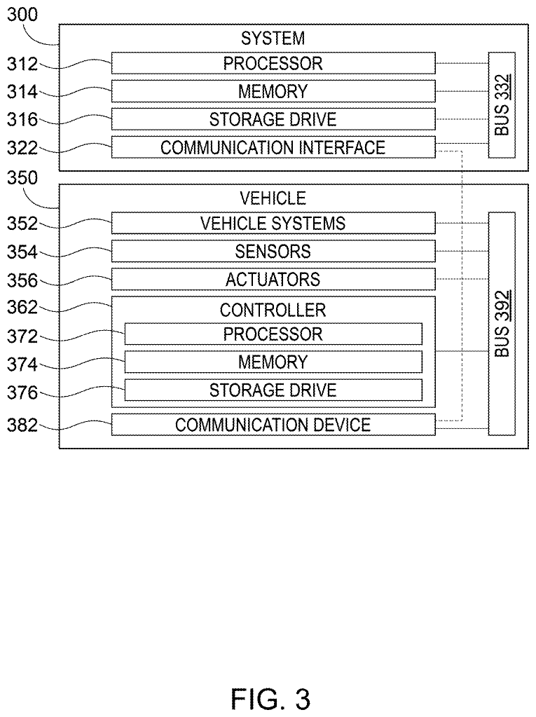

FIG. 3 is a component diagram of an exemplary system 300 for scenario-based prediction, according to one aspect. The system 300 for scenario-based prediction may include a processor 312, a memory 314, a storage drive 316, a communication interface 322, and a bus 332. The processor 312, the memory 314, the storage drive 316, and the communication interface 322 may be operably connected via the bus 332 and in computer communication with one another. According to one aspect, the system 300 for scenario-based prediction may include or be implemented on a vehicle 350. The vehicle 350 may include one or more vehicle systems 352, one or more sensors 354, one or more actuators 356, a controller 362, and a communication device 382. The controller 362 may include a processor 372, a memory 374, and a storage drive 376. The one or more vehicle systems 352, the one or more sensors 354, the one or more actuators 356, the controller 362, and the communication device 382 may be operably connected via the bus 392 and in computer communication with one another. Additionally, the communication device 382 of the vehicle 350 and the communication interface 322 may be in computer communication with one another via an operable connection which may be a direct connection or a wireless connection, for example. It will be appreciated that while the calculations, determinations, processing, etc. of the system 300 for scenario-based prediction are described with respect to the processor 312, the processor 372 of the controller 362 of the vehicle 350 may perform these calculations, determinations, processing according to other aspects. According to one aspect, the memory 314 may store one or more instructions. The processor 312 may execute one or more of the instructions stored on the memory 314 to perform one or more acts, actions, and/or steps.

### Methodology

A good predictor may help to improve the SDV's driving performance, and a robust evaluation method may identify the correlation between the prediction and driving performance. In this section, the problem may be defined for evaluating trajectory predictors based on their impact on closed-loop driving performance, propose a concrete evaluation framework ED-Eva, that simultaneously considers geometric error and diversity based on the scenarios.

### Problem Formulation

Consider an autonomous driving system that operates within a set of scenarios [symbol] . Each scenario s∈ [symbol] specifies the initial conditions, such as road geometry, agent states, and traffic configurations. Let [symbol] denote a distribution over scenarios, representing the conditions under which perform the evaluation. Define the following components:

Definition 1 (Predictor and Predicted Trajectory) A trajectory predictor Pᵢ takes as input the observation of scenario s, including the ego-vehicle's state, surrounding agents, and environmental context, and produces predicted trajectories:

$${P}_{i} : s ↦ {\hat{τ}}^{( i )} = ( {\hat{τ}}_{1}^{( i )} , … , {\hat{τ}}_{M}^{( i )} ) \qquad ( 1 )$$

where

$${\hat{τ}}_{j}^{( i )}$$

is the predicted trajectory of agent j, and i denotes the prediction comes from predictor Pᵢ.

Denote a fixed motion-planning policy π as a planner by:

Definition 2 (Planner) A fixed planner π generates an executed ego-trajectory τ^{ego} conditioned on the current scenario and the predicted trajectories:

τ^{ego}=π(s,\hat{τ}⁽ⁱ⁾) (2)

where \hat{τ}⁽ⁱ⁾ includes the trajectories of surrounding agents, the planner will perform maneuvers on vehicles based on the provided information.

To measure how the ego-planner performs after integrating the predictions, define a driving performance function:

Definition 3 (Driving Performance) The quality of an executed ego-trajectory is measured by the following function:

R(τ^{ego},s) (3)

which jointly captures minimizing collisions, comfort (e.g., reflected by jerk), and efficiency (e.g., travel time).

Based on the Equation (2), the driving performance induced by Pᵢ in scenario s may be written as:

R(Pᵢ,S)=R(π(\hat{τ}(i),s),s) (4)

Under a distribution [symbol] over scenarios, the expected driving performance of predictor Pᵢ is:

R̅(Pᵢ)= [symbol] _{s~D}[R(Pᵢ,s)] (5)

which quantifies how Pᵢ contributes to the SDV's overall performance that may include comfort and efficiency. Formalize the problem as below:

Problem 1 (Robust Predictor Evaluation) Given a set of Predictors {Pᵢ}, the goal is to find a measurement [symbol] that evaluates each predictor Pᵢ that reflects its driving performance R(Pᵢ, s), where [symbol] (Pᵢ) is a scalar score for the i^{th} predictor. If P* is selected by:

$${P}^{*} = arg {max}_{{P}_{i} ∈ 𝒫} ℳ ( {P}_{i} ) \qquad ( 6 )$$

Then P* may maximize R̅(Pᵢ), e.g., yield the best expected driving performance among the candidate predictors:

[symbol]

(Pᵢ)> [symbol] (Pⱼ)⇒R̅(Pᵢ)≥R̅(Pᵢ) (7)

Since traditional error-based metrics [symbol] (e.g., ADE), only measure pointwise errors between predicted and ground-truth trajectories, ignoring how these errors propagate through the planner. Thus, the processor 312 seeks to create a measurement M that captures planner-predictor interactions, resulting in a stronger correlation with real-world driving outcomes.

### Prediction Diversity Measure: Gad

It is important to understand the complexity of the scenario and consider its type based on FIG. 1. Thus, in this section, measure the ability to capture the complex future trajectories by quantifying the diversity of its predictions.

The system may adopt the concept of ‘spread’ to understand the diversity of a set of N predicted trajectories over a horizon of Ty time-steps. At each time t, the processor 312 may fit a two-dimensional Gaussian mixture model (GMM) for each prediction index n to the ensemble of trajectory endpoints

$${\{ ( {x}_{t , i}^{( n )} , {y}_{t ,}^{( n )} ) \}}_{i = 1}^{K} .$$

The processor 312 may collapse the GMM to a single 2×2 covariance matrix:

$${\sum }_{t}^{( n )} = {\sum }_{k = 1}^{K} {w}_{k} ( {μ}_{k} - \overline{μ} ) {( {μ}_{k} - \overline{μ} )}^{⊤} + {\sum }_{k = 1}^{K} {w}_{k} {C}_{k} \qquad ( 8 )$$

where wₖ, μₖ, Cₖ are the weight, mean, and covariance of component k, and μ̅=Σₖwₖμₖ, The processor 312 may perform an eigen-decomposition as shown below (Q is the orthogonal matrix of eigenvectors from the decomposition process):

$${\sum }_{t}^{( n )} = Q ( \begin{matrix}{λ}_{1} & 0 \\ 0 & {λ}_{2}\end{matrix} ) {Q}^{⊤} , {λ}_{1} \geq {λ}_{2} \geq 0 \qquad ( 9 )$$

The lengths of the principal semi-axes of the one-standard-deviation uncertainty ellipse are: a₁=\sqrt{λ₁}, a₂=\sqrt{λ₂}.

Based on this, its geometric area may be derived as:

$$𝒜 ( {\sum }_{t}^{( n )} ) = π {a}_{1} {a}_{2} = π \sqrt{{λ}_{7} {λ}_{2}} = π \sqrt{det ( {\sum }_{t}^{( n )} )} \qquad ( 10 )$$

Since each of the diversity measures of a predictor, it contains π, thus, the processor 312 may drop the constant factor It and define the per-prediction, per-time diversity score as below:

$$𝒟 ( {\sum }_{t}^{( n )} ) = \sqrt{det ( {\sum }_{t}^{( n )} )} \qquad ( 11 )$$

The processor 312 may average over all N trajectories and Tₚ steps yield the overall GMM-Area Diversity (GAD) below:

$$G A D = \frac{7}{N {T}_{P}} {\sum }_{n = 1}^{N} {\sum }_{t = 1}^{{T}_{p}} \sqrt{det ( {\sum }_{t}^{( n )} )} \qquad ( 12 )$$

The GAD captures spread along both principal axes rather than only the maximal direction, yielding truly bidirectional sensitivity. By fitting a full-covariance GMM and aggregating component covariances, it smooths over individual outliers for robust summarization. Besides, the required eigen-decomposition of a 2×2 matrix is closed-form and incurs negligible computational cost on top of GMM fitting.

### Prediction Displacement Measure Eₑᵣᵣₒᵣ

In scenarios with low interaction complexity (e.g., highways), simple error-based metrics are often sufficient to gauge predictor performance. Error-Based Measure Eₑᵣᵣₒᵣ may be thus incorporated into the framework. The general idea is to compare each predicted trajectory against the ground-truth future. Denote the set of N predicted trajectories over a horizon of Tₚ steps:

$$\{ {\hat{p}}_{t}^{( n )} \vert t = 1 , … , {T}_{p} ; n = 1 , … , N \}$$

and the corresponding ground-truth trajectory by {\hat{p}*ₜ|t=1, . . . , Tₚ}. The error measure may be represented by a generic function:

$${E}_{e r r o r} ( \{ \hat{p} \} , \{ {p}^{*} \} ) = \frac{1}{N {T}_{p}} {\sum }_{n = 1}^{N} {\sum }_{t = 1}^{{T}_{p}} ‖ {\hat{p}}_{t}^{( n )} - {p}_{t}^{*} ‖ \qquad ( 13 )$$

This expression may be instantiated in multiple ways, e.g., by only the final timestep (FDE), by the best of N modes (minADE/minFDE), by averaging top-K modes (aveADE), or other common variants without changing the overall framework. Adopt ADE as the Eₑᵣᵣₒᵣ.

### Scenario Classifier: Scenario NN

The scenario neural network may be developed to predict the type of scenario probability. It builds upon a spatial-temporal graph network that leverages a graph [symbol] to describe the spatial information. It takes the states of the ego-vehicle and its nearest N 3 neighbors as input for one graph [symbol] ₜ and collects a fixed horizon, e.g., T=15 to capture the temporal features. At each timestep t∈{1, . . . , T}, the [symbol] ₜ is constructed by node feature tensor X∈ [symbol] ^{T×N×F}, where N is also the number of nodes and F containing 14 features per node: from 3D position (x, y, z), velocity, acceleration, and a 5-dimensional relative-motion aggregation over its neighbors. The spatial relations are encoded by an adjacency matrix A∈ [symbol] ^{N×N} computed from the 2D positions at t=1:

$${A}_{i j} = \frac{𝕀 \{ ‖ {p}_{i}^{1} - {p}_{j}^{1} ‖ < {d}_{t h} \} + {δ}_{i j}}{{\sum }_{k = 1}^{N} ( 𝕀 \{ ‖ {p}_{i}^{1} - {p}_{k}^{1} ‖ < {d}_{t h} \} + {δ}_{i k} )} \qquad ( 14 )$$

where dₜₕ=5 m and δᵢⱼ adds self-loops before row-normalization. At each t, two graph-convolution layers as:

$${H}_{t}^{( ℓ + 1 )} = ReLU ( {AH}_{t}^{( ℓ )} {W}^{( ℓ )} ) , {H}_{t}^{( 0 )} = {X}_{t} \qquad ( 15 )$$

The processor 312 may mean-pool over the N nodes to obtain a sequence

$${\{ {g}_{t} \}}_{t = 1}^{T} ⊂ {ℝ}^{{d}_{g}} .$$

The temporal patterns are captured by feeding this sequence into an LSTM of a hidden size, e.g., dₕ=32. Denoting the LSTM's final hidden state by h_{T}, a linear head produces a logit:

[symbol]

=w^{T}h_{T}+b (16)

Based on this, a sigmoid function gives the probability P_{c}=ŷ=σ( [symbol] ) that the scenario is of a first type or second type. During training, the processor 312 may balance positive (e.g., collision-check) and negative samples using weighted sampling and optimize binary cross-entropy. At test time, the probability will be used to weight the GAD and Eₑᵣᵣₒᵣ as shown in Equation (17) below.

### Overview of ED-Eva Framework

Returning to FIG. 2, the framework unifies: Scenario Estimation, Diversity and Error Balance in a closed-loop process. First, the spatio-temporal history of the ego-vehicle and its neighbors is extracted into a sequence of graphs [symbol] ₁ . . . [symbol] ₂ and passed to the scenario classifier ScenarioNN, which outputs the probability P_{c} that the current scenario is of a first type (e.g., emphasis on diversity) and 1−P_{c} that it is ‘simple’ scenario of a second type (e.g., emphasis on accuracy). Second, the trajectory predictor generates N future paths, which are scored independently by the diversity measure GAD and the Error Metric Eₑᵣᵣₒᵣ. During implementation, the processor 312 may take a negative error-based metric value to align the direction with diversity. Finally, these two signals are combined into a single evaluation score via:

Score=P_{c}·GAD+(1−P_{c})·Eₑᵣᵣₒᵣ (17)

This adaptive fusion ensures that in highly interactive scenes, the emphasis falls on diversity, whereas in straightforward, low-risk scenarios, the focus remains on geometric accuracy.

According to one aspect, the processor 312 may perform receiving one or more past trajectories of one or more traffic participants from a traffic scenario. Additionally, the processor 312 may perform transforming the one or more past trajectories of the one or more traffic participants from the traffic scenario into a graph format for the scenario neural network. For example, the processor 312 may generate one or more graph stacks indicative of the past trajectories of the traffic participants at different times.

### Scenario Probability

The processor 312 may perform generating a probability that the traffic scenario is of a first scenario type or a second scenario type based on one or more past trajectories of one or more traffic participants from the traffic scenario and a scenario neural network. The first scenario type may be a scenario including an intersection (e.g., more complex operating environment) and the second scenario type may be a scenario including a highway or a roadway without intersections (e.g., less complex operating environment) within a threshold distance of the ego-vehicle.

### Trajectory Prediction

The processor 312 may perform generating one or more predicted trajectories for one or more traffic participants from the traffic scenario based on the one or more past trajectories and a predictor.

### Evaluation

The processor 312 may perform evaluating the predictor based on a score calculated based on the probability that the traffic scenario is the first scenario type or the second scenario type, an area diversity model, and a geometric error model. The area diversity model may generate an output indicative of a spatial spread of the one or more predicted trajectories. The geometric error model may generate an output indicative of average displacement error (ADE). The area diversity model may be a Gaussian Mixture Model (GMM) area diversity model (GAD). According to one aspect, the processor 312 may perform updating the predictor based on the score.

According to one aspect, the score may be equal to the probability that the traffic scenario is the first scenario type multiplied by an output of the area diversity model summed with the probability that the traffic scenario is the second scenario type multiplied by an output of the geometric error model.

### Path Planning

According to one aspect, the processor 312 may perform generating a planned trajectory for an ego-vehicle of one or more of the traffic participants based on the one or more predicted trajectories and the probability that the traffic scenario is of the first scenario type or the second scenario type. Further, the processor 312 may perform implementing the planned trajectory for the ego-vehicle using one or more vehicle systems 352 of the ego-vehicle, thereby causing the ego-vehicle (e.g., vehicle 350) to operate according to the planned trajectory.

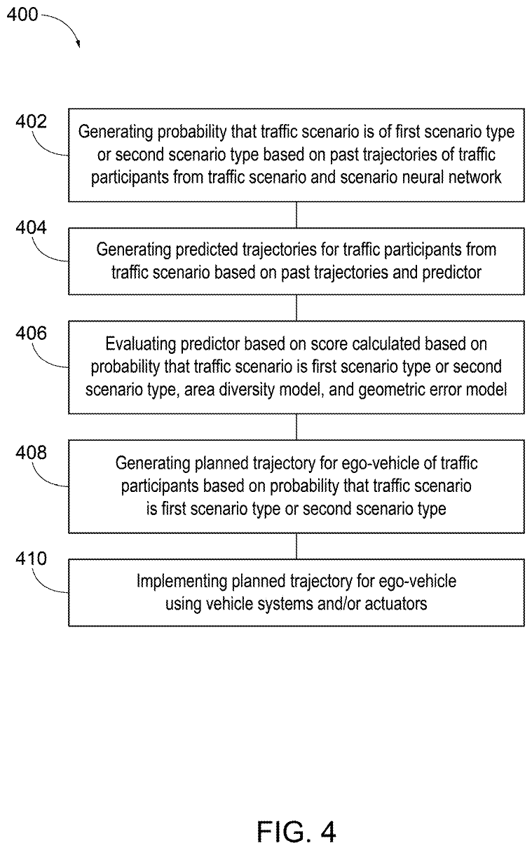

FIG. 4 is a flow diagram of an exemplary computer-implemented method 400 for scenario-based prediction, according to one aspect. The computer-implemented method 400 for scenario-based prediction may include generating 402 a probability that a traffic scenario is of a first scenario type or a second scenario type based on one or more past trajectories of one or more traffic participants from the traffic scenario and a scenario neural network, generating 404 one or more predicted trajectories for one or more traffic participants from the traffic scenario based on the one or more past trajectories and a predictor, evaluating 406 the predictor based on a score calculated based on the probability that the traffic scenario is the first scenario type or the second scenario type, an area diversity model, and a geometric error model, generating 408 a planned trajectory for an ego-vehicle of one or more of the traffic participants based on the one or more predicted trajectories and the probability that the traffic scenario is of the first scenario type or the second scenario type, and implementing 410 the planned trajectory for the ego-vehicle using one or more vehicle systems of the ego-vehicle.

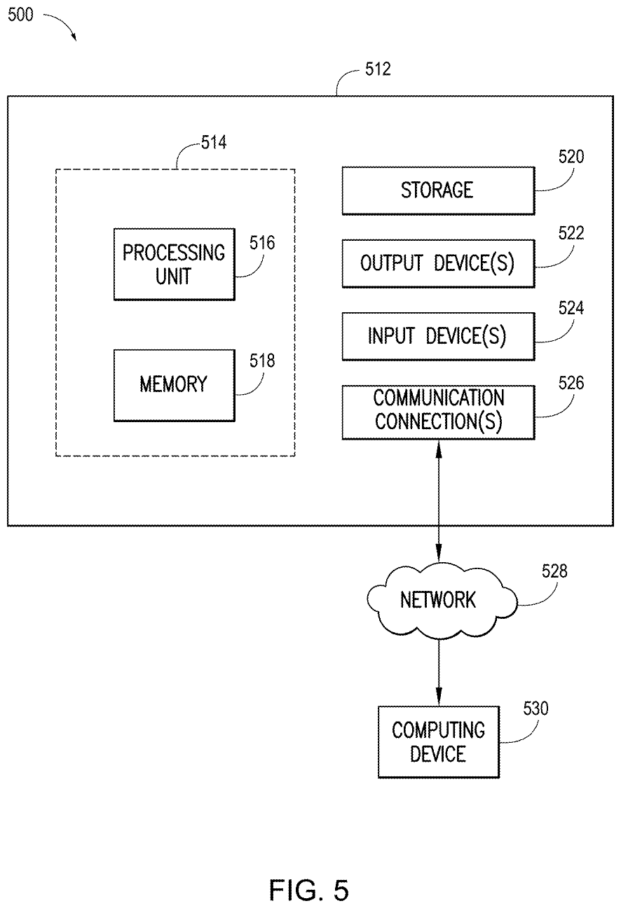

FIG. 5 and the following discussion provide a description of a suitable computing environment to implement aspects of one or more of the provisions set forth herein. The operating environment of FIG. 5 is merely one example of a suitable operating environment and is not intended to suggest any limitation as to the scope of use or functionality of the operating environment. Example computing devices include, but are not limited to, personal computers, server computers, hand-held or laptop devices, mobile devices, such as mobile phones, Personal Digital Assistants (PDAs), media players, and the like, multiprocessor systems, consumer electronics, mini-computers, mainframe computers, distributed computing environments that include any of the above systems or devices, etc.

Generally, aspects are described in the general context of “computer readable instructions” being executed by one or more computing devices. Computer readable instructions may be distributed via computer readable media as will be discussed below. Computer readable instructions may be implemented as program modules, such as functions, objects, Application Programming Interfaces (APIs), data structures, and the like, that perform one or more tasks or implement one or more abstract data types. Typically, the functionality of the computer readable instructions is combined or distributed as desired in various environments.

FIG. 5 illustrates a system 500 including a computing device 512 configured to implement one aspect provided herein. In one configuration, the computing device 512 includes at least one processing unit 516 and memory 518. Depending on the exact configuration and type of computing device, memory 518 may be volatile, such as RAM, non-volatile, such as ROM, flash memory, etc., or a combination of the two. This configuration is illustrated in FIG. 5 by dashed line 514.

In other aspects, the computing device 512 includes additional features or functionality. For example, the computing device 512 may include additional storage such as removable storage or non-removable storage, including, but not limited to, magnetic storage, optical storage, etc. Such additional storage is illustrated in FIG. 5 by storage 520. In one aspect, computer readable instructions to implement one aspect provided herein are in storage 520. Storage 520 may store other computer readable instructions to implement an operating system, an application program, etc. Computer readable instructions may be loaded in memory 518 for execution by the at least one processing unit 516, for example.

The term “computer readable media” as used herein includes computer storage media. Computer storage media includes volatile and nonvolatile, removable, and non-removable media implemented in any method or technology for storage of information such as computer readable instructions or other data. Memory 518 and storage 520 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which may be used to store the desired information and which may be accessed by the computing device 512. Any such computer storage media is part of the computing device 512.

The term “computer readable media” includes communication media. Communication media typically embodies computer readable instructions or other data in a “modulated data signal” such as a carrier wave or other transport mechanism and includes any information delivery media. The term “modulated data signal” includes a signal that has one or more of its characteristics set or changed in such a manner as to encode information in the signal.

The computing device 512 includes input device(s) 524 such as keyboard, mouse, pen, voice input device, touch input device, infrared cameras, video input devices, or any other input device. Output device(s) 522 such as one or more displays, speakers, printers, or any other output device may be included with the computing device 512. Input device(s) 524 and output device(s) 522 may be connected to the computing device 512 via a wired connection, wireless connection, or any combination thereof. In one aspect, an input device or an output device from another computing device may be used as input device(s) 524 or output device(s) 522 for the computing device 512. The computing device 512 may include communication connection(s) 526 to facilitate communications with one or more other devices 530, such as through network 528, for example.

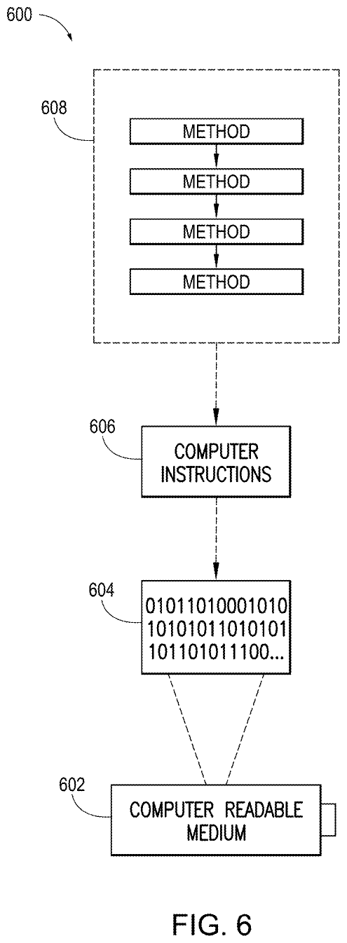

Still another aspect involves a computer-readable medium including processor-executable instructions configured to implement one aspect of the techniques presented herein. An aspect of a computer-readable medium or a computer-readable device devised in these ways is illustrated in FIG. 6, wherein an implementation 600 includes a computer-readable medium 602, such as a CD-R, DVD-R, flash drive, a platter of a hard disk drive, etc., on which is encoded computer-readable data 604. This encoded computer-readable data 604, such as binary data including a plurality of zero's and one's as shown in 604, in turn includes a set of processor-executable computer instructions 606 configured to operate according to one or more of the principles set forth herein. In this implementation 600, the processor-executable computer instructions 606 may be configured to perform a method 608, such as the computer-implemented method 400 for scenario-based prediction of FIG. 4. In another aspect, the processor-executable computer instructions 606 may be configured to implement a system, such as the system 300 for scenario-based prediction of FIG. 3. Many such computer-readable media may be devised by those of ordinary skill in the art that are configured to operate in accordance with the techniques presented herein.

As used in this application, the terms “component”, “module,” “system”, “interface”, and the like are generally intended to refer to a computer-related entity, either hardware, a combination of hardware and software, software, or software in execution. For example, a component may be, but is not limited to being, a process running on a processor, a processing unit, an object, an executable, a thread of execution, a program, or a computer. By way of illustration, both an application running on a controller and the controller may be a component. One or more components residing within a process or thread of execution and a component may be localized on one computer or distributed between two or more computers.

Further, the claimed subject matter is implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

Although the subject matter has been described in language specific to structural features or methodological acts, it is to be understood that the subject matter of the appended claims is not necessarily limited to the specific features or acts described above. Rather, the specific features and acts described above are disclosed as example aspects.

Various operations of aspects are provided herein. The order in which one or more or all of the operations are described should not be construed as to imply that these operations are necessarily order dependent. Alternative ordering will be appreciated based on this description. Further, not all operations may necessarily be present in each aspect provided herein.

As used in this application, “or” is intended to mean an inclusive “or” rather than an exclusive “or”. Further, an inclusive “or” may include any combination thereof (e.g., A, B, or any combination thereof). In addition, “a” and “an” as used in this application are generally construed to mean “one or more” unless specified otherwise or clear from context to be directed to a singular form. Additionally, at least one of A and B and/or the like generally means A or B or both A and B. Further, to the extent that “includes”, “having”, “has”, “with”, or variants thereof are used in either the detailed description or the claims, such terms are intended to be inclusive in a manner similar to the term “comprising”.

Further, unless specified otherwise, “first”, “second”, or the like are not intended to imply a temporal aspect, a spatial aspect, an ordering, etc. Rather, such terms are merely used as identifiers, names, etc. for features, elements, items, etc. For example, a first channel and a second channel generally correspond to channel A and channel B or two different or two identical channels or the same channel. Additionally, “comprising”, “comprises”, “including”, “includes”, or the like generally means comprising or including, but not limited to.

It will be appreciated that various of the above-disclosed and other features and functions, or alternatives or varieties thereof, may be desirably combined into many other different systems or applications. Also, that various presently unforeseen or unanticipated alternatives, modifications, variations, or improvements therein may be subsequently made by those skilled in the art which are also intended to be encompassed by the following claims.

1. A system for scenario-based prediction, comprising:
a memory storing one or more instructions; and
a processor executing one or more of the instructions stored on the memory to perform:
generating a probability that a traffic scenario is of a first scenario type or a second scenario type based on one or more past trajectories of one or more traffic participants from the traffic scenario and a scenario neural network;
generating one or more predicted trajectories for one or more traffic participants from the traffic scenario based on the one or more past trajectories and a predictor; and
evaluating the predictor based on a score calculated based on the probability that the traffic scenario is the first scenario type or the second scenario type, an area diversity model, and a geometric error model.

2. The system for scenario-based prediction of claim 1, wherein the processor generates a planned trajectory for an ego-vehicle of one or more of the traffic participants based on the one or more predicted trajectories and the probability that the traffic scenario is of the first scenario type or the second scenario type.

3. The system for scenario-based prediction of claim 2, wherein the processor implements the planned trajectory for the ego-vehicle using one or more vehicle systems of the ego-vehicle.

4. The system for scenario-based prediction of claim 1, wherein the first scenario type is a scenario including an intersection and the second scenario type is a scenario including a highway or a roadway without intersections.

5. The system for scenario-based prediction of claim 1, wherein the processor transforms the one or more past trajectories of the one or more traffic participants from the traffic scenario into a graph format for the scenario neural network.

6. The system for scenario-based prediction of claim 1, wherein the area diversity model is a Gaussian Mixture Model (GMM) area diversity model (GAD).

7. The system for scenario-based prediction of claim 1, wherein the area diversity model generates an output indicative of a spatial spread of the one or more predicted trajectories.

8. The system for scenario-based prediction of claim 1, wherein the geometric error model generates an output indicative of average displacement error (ADE).

9. The system for scenario-based prediction of claim 1, wherein the score is equal to the probability that the traffic scenario is the first scenario type multiplied by an output of the area diversity model summed with the probability that the traffic scenario is the second scenario type multiplied by an output of the geometric error model.

10. The system for scenario-based prediction of claim 1, wherein the processor updates the predictor based on the score.

11. A computer-implemented method for scenario-based prediction, comprising:
generating a probability that a traffic scenario is of a first scenario type or a second scenario type based on one or more past trajectories of one or more traffic participants from the traffic scenario and a scenario neural network;
generating one or more predicted trajectories for one or more traffic participants from the traffic scenario based on the one or more past trajectories and a predictor; and
evaluating the predictor based on a score calculated based on the probability that the traffic scenario is the first scenario type or the second scenario type, an area diversity model, and a geometric error model.

12. The computer-implemented method for scenario-based prediction of claim 11, comprising generating a planned trajectory for an ego-vehicle of one or more of the traffic participants based on the one or more predicted trajectories and the probability that the traffic scenario is of the first scenario type or the second scenario type.

13. The computer-implemented method for scenario-based prediction of claim 12, comprising implementing the planned trajectory for the ego-vehicle using one or more vehicle systems of the ego-vehicle.

14. The computer-implemented method for scenario-based prediction of claim 11, wherein the first scenario type is a scenario including an intersection and the second scenario type is a scenario including a highway or a roadway without intersections.

15. The computer-implemented method for scenario-based prediction of claim 11, comprising transforming the one or more past trajectories of the one or more traffic participants from the traffic scenario into a graph format for the scenario neural network.

16. A system for scenario-based prediction, comprising:
one or more vehicle systems;
a memory storing one or more instructions; and
a processor executing one or more of the instructions stored on the memory to perform:
generating a probability that a traffic scenario is of a first scenario type or a second scenario type based on one or more past trajectories of one or more traffic participants from the traffic scenario and a scenario neural network;
generating one or more predicted trajectories for one or more traffic participants from the traffic scenario based on the one or more past trajectories and a predictor;
evaluating the predictor based on a score calculated based on the probability that the traffic scenario is the first scenario type or the second scenario type, an area diversity model, and a geometric error model; and
generating and implementing a planned trajectory for an ego-vehicle of one or more of the traffic participants based on the one or more predicted trajectories and the probability that the traffic scenario is of the first scenario type or the second scenario type using one or more of the vehicle systems.

17. The system for scenario-based prediction of claim 16, wherein the first scenario type is a scenario including an intersection and the second scenario type is a scenario including a highway or a roadway without intersections.

18. The system for scenario-based prediction of claim 16, wherein the processor transforms the one or more past trajectories of the one or more traffic participants from the traffic scenario into a graph format for the scenario neural network.

19. The system for scenario-based prediction of claim 16, wherein the area diversity model is a Gaussian Mixture Model (GMM) area diversity model (GAD).

20. The system for scenario-based prediction of claim 16, wherein the area diversity model generates an output indicative of a spatial spread of the one or more predicted trajectories.
